(19) United States
(12) Patent Application Publication
(10) Pub. No.: US 2003/0004246 A1
(43) Pub. Date: Jan. 2, 2003

(54) Powdery composition based on water-soluble polymers

(76) Inventors: Steffen Wache, Erlingen (DE); Mathias Degenkolb, Augsburg (DE); Klaus Hotzl, Augsburg (DE); Jana Kellermann, Augsburg (DE)

Correspondence Address: FULBRIGHT & JAWORSKI, LLP, 666 FIFTH AVE, NEW YORK, NY, 10103-3198, US

(21) Appl. No.: 10/182,220

(22) PCT Filed: Feb. 8, 2001
(86) PCT No.: PCT/EP01/01367

(30) Foreign Application Priority Data
Feb. 9, 2000 (DE) 100 05 707.1

(51) Int. Cl. C08K 3/26; C08K 3/34; C08K 3/40

(52) U.S. Cl. 524/425; 524/492; 524/494; 524/445; 524/451; 524/449

(57) ABSTRACT

The powdery composition based on water-soluble polymers essentially contains

a) 5 to 95 wt. % of a water-soluble polymer which is made up of sulfonates of lignin and/or sulfonated melamine-formaldehyde, naphthalene-formaldehyde and/or ketone-formaldehyde condensation products, and

b) 5 to 95 wt. % of a fine particle mineral support material with a preferred specific surface area of 0.01 to 500 m²/g.

Calcium carbonate, dolomite, clays, fly ashes, Portland cements and gypsum are suitable typical support materials and for this purpose should preferably have a particle size of 0.1 to 1,000 μm. Also claimed is a process for the production of this composition, wherein the water-soluble polymer is above all incorporated into the particular support material, which in particular takes place in the form of an aqueous solution in a least one step and can also involve intermediate drying steps. These compositions are used in amounts of 0.05 to 5 wt. % of polymer in building materials such as bitumen products, cement, calcium-based building materials and/or oil field building materials, during which they can also be combined with other building material additives and filler admixtures. The powdery compositions are characterized inter alia by their very good pourability, they are tack-free and extremely easy to meter in and to process and favorably influence product properties such as flowability.

The object of the present invention is a powdery composition, processes for its production and its use in building materials.

Polymer additives for building materials, such as bitumen, mortars and fillers are very well known and in widespread use. Appropriate polymers or polymer mixtures can be added to these products for example in solid or in liquid, and then mostly aqueous, form.

However, the use of aqueous polymer solutions in particular is associated with considerable disadvantages, since for example their storage is not without problems; thus they must not come into contact with corrosion-sensitive metals and are moreover sensitive to strong heating and also to the action of frost. Moreover, aqueous polymer solutions must be protected against attack by microorganisms, which renders the addition of preservatives and sometimes costly measures for tank hygiene necessary.

The use of aqueous polymer solutions for the modification of hot building materials, such as bitumen or asphalt is especially problematic, since an aqueous polymer solution can only be incorporated very slowly owing to the spontaneous evolution of steam occurring during this. Moreover, there is an increased accident risk from spraying and delayed ebullition.

The use of aqueous polymer solutions can be completely ruled out in use fields in which the polymers are needed in dry mixtures prepared on site.

For the said reasons, it is thus often useful to incorporate polymers or polymer mixtures in solid form, to be precise mostly as powder, into the building materials to be modified.

In addition to logistic and economic advantages (transport of water), powders also have a range of technical advantages over aqueous preparations. Stabilization against attack by microorganisms through the addition of biocides is not necessary, nor are the sometimes costly measures for tank hygiene.

It is known that polymer powders can be prepared by spraying of aqueous polymer solutions into a hot air flow (spray drying), during which spraying aids are advantageously added.

However, the temperatures used in spray drying (up to 200° C.) have an adverse effect on the polymers thus to be dried. Hence for example temperature instability of the polymers is to be observed under the conditions of the spray drying, which sometimes leads to insoluble residues on redissolution of the powder in water.

In addition, depending on the process, the spray drying process can lead to different particle size distributions in the powders so produced, which has an adverse effect on the dissolution behavior of these powders in aqueous building material systems and hence can adversely affect the product quality of building material mixtures.

In the spray drying of sulfonated melamine-formaldehyde condensation products, high temperatures at the appropriate pH value can lead to changes in the resin, such as further alkaline condensation. The by-products thus arising have an adverse effect in the use of such powders in building material mixtures.

These disadvantages, and also the high energy requirement of spray drying, are however still accepted, in order to obtain the polymers in the form of pourable, tack-free powders.

Hence the invention was based on the problem of providing a powdery composition which does not display the aforesaid disadvantages and which is in particular suitable for long storage and transport times, which is largely insensitive to extreme temperatures such as frost and heat, which requires no preservatives, and which can moreover be incorporated into a hot premix faster and with lower hazard than conventional spray dried polymer compositions. The composition should in addition be producible with as low an energy usage as possible, and finally it should not adversely affect the properties of products which are treated with the composition.

This problem has been solved with a powdery composition based on water-soluble polymers, which is characterized in that it contains

a) 5-95 wt. % of a water-soluble polymer which is made up of sulfonates of lignin and/or sulfonated melamine-formaldehyde, naphthalene-formaldehyde and/or ketone-formaldehyde condensation products, and

b) 5-95 wt. % of a fine particle mineral support material.

Surprisingly, it was found that by means of this combination of a water-soluble polymer and a fine particle support material, pourable, tack-free and very easily processed powdery compositions are obtained, which in addition are simple to produce without great technical expense and are simple and inexpensive to pack and which are especially suitable for long transport and storage times, since no preservatives are necessary and there is no risk due to frost. In addition, they can also be readily and rapidly incorporated into hot premixes, for example into a hot bitumen melt.

There is no particular restriction as to the definition of the water-soluble polymers contained in the powdery composition according to the invention. It is important only that they can readily be applied to the support materials used according to the invention and in this support-bound form still display the desired action after incorporation into the matrix.

Sulfonates of lignin and also melamine-formaldehyde, naphthalene-formaldehyde and/or ketone-formaldehyde condensation products, which are sulfonated for water-solubility, are known flow agents for mineral binders and in particular cement-based building materials; however they are also added from building materials to reduce water loss (as so-called “fluidloss additives”), particularly in crude oil extraction.

In the sense of the present invention, a fine particle mineral support material which has a specific surface area of 0.01 to 500 m²/g (after BET in accordance with DIN 66,131) and which is in particular selected from the group calcium carbonate, dolomite, quartz flour, quartz sand, silica dust, cristobalite, silicic acid, clays, clay minerals, aluminum silicates (such as bentonite, talc, mica, kaolins, slate flour), pumice flour, brick dust, titanium dioxide, argillaceous clays, barium sulfate, fly ash, smelter sand/blast furnace slag, Portland cement, Portland cement with added powdered substances (CEM IT and CEM III), alumina cements, gypsum, anhydrite, hemihydrate, limestone and mixtures of these materials has proved excellently suitable as component b).

Thus there is no particular restriction as to the nature of these support materials. It is important that the particular material/material mixture shows good compatibility with the water-soluble polymer, does not adversely effect the action of the polymer and even in small amounts yields powdery tack- and packing-resistant compositions.

In addition to this, the invention also provides for the use of the mineral support materials in combination with organic additives such as cellulose powders or fibers and powders or fibers of organic polymers (polyacrylonitrile, polystyrene, etc.).

The fine particle support material has a preferred particle size of 0.1 to 1,000 μm.

Also an object of the invention is a process for the production of the powdery composition, which is characterized in that the water-soluble polymer/(polymer mixture) is incorporated into the respective mineral support material/(material mixture), which is preferably effected directly after the polymerization production process. Here the polymer should be introduced into the already present and optionally preheated mineral support material in as finely divided form as possible, during which the polymer in the form of an aqueous solution is incorporated into the mineral support material in at least one step, which according to the invention can also optionally take place after intermediate drying.

It is also provided that the aqueous solution of the polymer can be subjected to intermediate drying before the incorporation step or steps.

According to a preferred embodiment, the relevant water-soluble polymer in the temperature range from 70 to 150° C. is sprayed onto a preheated mineral support material (for example of the silicic acid type), which should ideally be effected in a mixer.

A particularly effective incorporation, which is associated with very low consumption of mineral support material, can be achieved by atomization of the water-soluble polymer onto the preheated support material. The effectiveness decreases when the polymer is sprayed, dropped or poured onto the support material, since the area of the substance to be incorporated decreases in the stated order.

Also of particular interest is the mixing technique during the incorporation, which depends very strongly on the type of support material used.

Support materials with pronounced porous structure, such as silicic acids, display particularly high adsorption capacity.

Mixers on whose mixing tools high shear forces come into operation can destroy the porous structure, as a result of which the polymers retained in the cavities are pressed out again. For this type of support, the present invention therefore recommends the use of mixing devices with low shear forces such as drum mixers, V-blenders, tumbler mixers or other types of gravity mixer.

Further, conical mixers, ploughshare mixers or spiral mixers with vertically or horizontally arranged mixing tools are likewise suitable for porous support materials. For mineral supports whose structure cannot be destroyed by the mixing process, all other types of device are also usable, such as dissolvers, screw mixers, double screw mixers and air-mix mixers.

As already mentioned, the present invention provides that one or several drying processes can be performed during the incorporation of the polymer into the support, in order to increase the effectiveness of the support material; also possible however is a drying process which follows the actual incorporation steps.

A further object of the invention is the use of at least one powdery composition according to the present invention in building materials, possible building materials being bitumen products, building materials based on hydraulically setting binders such as cement or latently hydraulic binders, gypsum-, anhydrite- or other calcium sulfate-based building materials, ceramic compounds, fireproof compounds and oilfield construction materials. Finally, the compositions according to the invention can also be used in dispersion-based building materials such as dispersion tile adhesives, elastic sealing slurries, primary coats, mortar bonding additives and in powdery interior and external wall paints.

The powdery compositions according to the invention can however also be used in combinations of the aforesaid building material groups, e.g. in bitumen-containing cement flow plaster floors, grouting mortars, etc.

The powdery composition is as a rule incorporated into the building material together with other building material additives and filler mixtures, possible building materials here being in particular those which consist of additives such as rock flour, pozzolanic and/or latently hydraulic additives, and admixtures such as plastic dispersions, water retention agents, thickeners, retardants, accelerators, air entraining agents, antifoaming agents and wetting agents. According to the invention the content of the composition in the building materials should be about 0.05 to 5 wt. % based on the total weight of the building material.

The powdery compositions according to the invention display a number of advantages compared to conventionally obtained compositions in powder form. This becomes clear above all in the building material mixture also claimed, which is preferably a dry mixture for flowable mortar and which contains

a) 10 to 50 wt. % of the powdery composition according to claims 1 to 5,

b) 20 to 60 wt. % of additives,

c) 30 to 70 wt. % of aggregates,

d) optionally up to 25 wt. % of admixtures,

e) optionally up to 10 wt. % of a plastic dispersion and

f) optionally up to 25 wt. % of an inorganic binder.

The following examples substantiate the advantages of the present invention.

### EXAMPLES

### Invention Examples

### Example 1

Dry Mixture for Flowable Mortars.

1.1:

A fine particle mineral support mixture consisting of 250 g of cement (CEM 152.5 R, Milke Co.) and 120 g of limestone flour (Calcicoll W 12) was placed in a dissolver and preheated to 40° C. Then, as water-soluble polymer, 20 g of Melment L 17 G (40% solution, SKW Trostberg AG; corresponding to 3.2% solids relative to CEM I) were incorporated at 2,000 rpm and the mixing process continued for 25 minutes at 2,000 rpm. In this way, a dry, pourable powdery composition was obtained, which was processed with 0.5 g of Tylose H 20 P as admixture and 700 g of sand as aggregate to give a finished dry mixture for flowable mortars.

1.2:

A fine particle mineral support mixture consisting of 250 g of cement (CEM 152.5 R, Milke Co.) and 120 g of limestone flour (Calcicoll W 12) and also 700 g of sand as aggregate was preheated to 45° C. and placed in a tumble mixer. Then, as water-soluble polymer, 32 g of Melment L 10 (25% aqueous solution, SKW Trostberg AG; corresponding to 3.2% solids relative to CEM I) were metered into this mixture and the mixing process was continued for 75 minutes. The dry, pourable mixture thus obtained was treated with 15 g of plastic dispersion powder.

### Example 2

Standard Mortar Mixture

450 g of cement (CEM I 42.5 R, Schwenk Co.) as support were placed in a dissolver and treated with 22.5 g of Melment L 17 G as water-soluble polymer (40% aqueous solution, SKW Trostberg AG; corresponding to 2.0% solids relative to CEM I) at 2,000 rpm. From the mixing process, which was continued for 25 minutes at 2,000 rpm, a dry, pourable powdery composition was obtained, to which finally 1,350 g of standard sand were added.

### Comparison Examples

### Example 1

Dry Mortar Mixture Consisting of:

250 g CEM 152.5 R, Milke Co.

120 g limestone flour (Calcicoll W 12)

700 g sand

8 g Melment F 17 G (corresponds to 3.2% relative to CEM I)

0.5 g Tylose H 20 P

### Example 2

Dry Mortar Mixture Consisting of:

250 g CEM 152.5 R, Milke Co.

120 g limestone flour (Calcicoll W 12)

700 g sand

8 g Melment F 10 (corresponds to 3.2% relative to CEM I)

15 g plastic dispersion powder

### Example 3

Standard Mortar Mixture According to EN-196 Consisting of:

450 g CEM I 42.5 R, Schwenk Co.

1350 g standard sand

9 g Melment F 17 G (corresponds to 2.0% relative to CEM I)

| Dry Mortars | Flow Value (cm)* |
|---|---|
| Invention example 1.1 | 24.0 |
| Comparison example 1 | 22.0 |
| Invention example 1.2 | 26.0 |
| Comparison example 2 | 23.5 |
| Standard Mortars | Spread value (cm)*¹ |
| Invention example 2 | 19.0 |
| Comparison example 3 | 16.0 |

*W/Z = 0.61
*¹W/Z = 0.39 (spread value without flowing agent 15.5 cm with W/Z = 0.5)

1. Powdery composition based on water-soluble polymers, characterized in that it contains:
a) 5 to 95 wt. % of a water-soluble polymer which is made up of sulfonates of lignin and/or sulfonated melamine-formaldehyde, naphthalene-formaldehyde and/or ketone-formaldehyde condensation products, and
b) 5 to 95 wt. % of a fine particle mineral support material.

2. Composition according to claim 1, characterized in that the fine particle mineral support material has a specific surface area of 0.01 to 500 m²/g (after BET in accordance with DIN 66,131).

3. Composition according to claim 1 or 2, characterized in that the support material is selected from the group calcium carbonate, dolomite, quartz flour, quartz sand, silica dust, cristobalite, silicic acid, clays, clay minerals, aluminum silicates (such as bentonite, talc, mica, kaolins, slate flour), pumice flour, brick dust, titanium dioxide, argillaceous clays, barium sulfate, fly ash, smelter sand/blast furnace slag, Portland cement, Portland cement with added powdered substances (CEM II and CEM III), alumina cements, gypsum, anhydrite, hemihydrate, limestone and mixtures of these materials.

4. Composition according to one of claims 1 to 3, characterized in that the mineral support material is used in combination with organic additives such as cellulose powders or fibers and powders or fibers of organic polymers.

5. Composition according to one of claims 1 to 4, characterized in that the support material has a mean particle size of 0.1 to 1,000 μm.

6. Process for the production of the composition according to one of claims 1 to 5, characterized in that the water-soluble polymer is incorporated into the mineral support material, preferably directly after the polymerization production process.

7. Process according to claim 6, characterized in that the polymer is incorporated into the mineral support material in the form of an aqueous solution in at least one step, optionally after intermediate drying.

8. Process according to claim 7, characterized in that the aqueous solution of the polymer is subjected to intermediate drying before the incorporation step or steps.

9. Process according to one of claims 6 to 8, characterized in that the water-soluble polymer is sprayed onto a preheated mineral support material at 70 to 150° C.

10. Process according to one of claims 6 to 9, characterized in that with a support material with a porous structure mixers with low shear forces, for example gravity mixers, are used.

11. Use of a composition according to one of claims 1 to 5 in building materials in a quantity of 0.05 to 5 wt. % of polymer relative to the total weight of the building material.

12. Use according to claim 11, characterized in that bitumen products, building materials based on hydraulically setting binders such as cement or latently hydraulic binders, gypsum-, anhydrite- or other calcium sulfate-based building materials, ceramic compounds, fireproof compounds, oilfield construction materials and dispersion-based building materials or mixtures thereof are used as building materials.

13. Use according to one of claims 11 and 12, characterized in that the powdery composition is combined with other building material additives and filler mixtures.

14. Use according to claim 13, characterized in that the other building material additives consist of additives, such as for example rock flour, pozzolanic and/or latently hydraulic additives, and admixtures, such as for example plastic dispersions, water retention agents, thickeners, retardants, accelerators, air entraining agents, antifoam agents and wetting agents.

15. Building material mixture, preferably dry mixture for flowable mortars, containing
a) 10 to 50 wt. % of the powdery composition according to one of claims 1 to 5,
b) 20 to 60 wt. % of additives,
c) 30 to 70 wt. % of aggregates,
d) optionally up to 25 wt. % of admixtures,
e) optionally up to 10 wt. % of a plastic dispersion and
f) optionally up to 25 wt. % of an inorganic binder.
